(19) United States
(12) Patent Application Publication
(10) Pub. No.: US 2012/0127471 A1
(43) Pub. Date: May 24, 2012

(54) INTERFERENCE FILTER, OPTICAL MODULE, AND OPTICAL ANALYZER

(75) Inventor: Tatsuo URUSHIDANI, Chino (JP)

(73) Assignee: SEIKO EPSON CORPORATION, Tokyo (JP)

(21) Appl. No.: 13/249,611

(22) Filed: Sep. 30, 2011

(30) Foreign Application Priority Data
Nov. 19, 2010 (JP) 2010-259044

(51) Int. Cl. G02B 26/00; G01B 9/02

(52) U.S. Cl. 356/450; 359/578

(57) ABSTRACT

An interference filter includes a fixed mirror and a movable mirror which are disposed so as to face each other with a gap therebetween. The fixed mirror is formed by laminating a one-layer TiO₂ film and a one-layer Ag alloy film. In addition, the movable mirror is formed by laminating a one-layer TiO₂ film and a one-layer Ag alloy film.

### BACKGROUND

1. Technical Field

The present invention relates to an interference filter, an optical module including the interference filter, and an optical analyzer including the optical module.

2. Related Art

An interference filter is known in which mirrors (a pair of mirrors) as reflective films, which are formed on opposite surfaces of a pair of substrates, are disposed so as to face each other with a gap therebetween (for example, refer to JP-A-2009-251105).

In the interference filter disclosed in JP-A-2009-251105, incident light is subjected to multiple interference between the pair of mirrors and only light with a specific wavelength intensified by the multiplex interference is transmitted through the interference filter.

For the mirrors, a material with high reflective and transmissive properties is required. Accordingly, fine silver (Ag) or an Ag alloy may be said to be a strong candidate. For this reason, in the interference filter disclosed in JP-A-2009-251105, an Ag—C alloy obtained by adding carbon (C) to Ag is used for the mirror.

In the interference filter disclosed in JP-A-2009-251105, however, it becomes easy to absorb light in a long wavelength range of near-infrared in the case of using the Ag—C alloy for the mirror. This lowers the resolution of the interference filter because the detected amount of light, which is transmitted through the mirrors in the long wavelength range of near-infrared light, is reduced compared with that in a short wavelength range.

### SUMMARY

An advantage of some aspects of the invention is to provide an interference filter capable of improving the resolution in a long wavelength range, an optical module, and an optical analyzer.

An aspect of the invention is directed to an interference filter including: a first reflective film; and a second reflective film disposed so as to face the first reflective film with a gap therebetween. The first reflective film is formed by laminating a one-layer transparent film and a one-layer metal film, and the second reflective film is formed by laminating a one-layer transparent film and a one-layer metal film.

According to the aspect of the invention, each reflective film is formed by laminating the one-layer transparent film and the one-layer metal film. In such a configuration, absorption of light with a specific wavelength by the metal film can be suppressed compared with a configuration in which only a metal film is formed or a configuration in which a metal film is formed on a dielectric multi-layer film. Accordingly, it is possible to suppress a decrease in the amount of transmitted light or a lowering in the resolution of the interference filter. As a result, it is possible to improve the resolution of the interference filter without reducing the amount of transmitted light in a long wavelength range of near-infrared light.

Preferably, the interference filter according to the aspect of the invention further includes: a first substrate; and a second substrate facing the first substrate. It is preferable that the first reflective film be provided on a surface of the first substrate facing the second substrate and be formed by laminating a one-layer transparent film and a one-layer metal film sequentially from the first substrate side. It is preferable that the second reflective film be provided on the second substrate, face the first reflective film with a predetermined gap therebetween, and be formed by laminating the one-layer transparent film and the one-layer metal film sequentially from the second substrate side.

According to this configuration, not only the effects described above can be obtained, but also the reflective film can be directly formed on the substrate since each reflective film is formed by laminating the one-layer transparent film and the one-layer metal film sequentially from the substrate side. Therefore, since the reflective film can be stably formed on the substrate, bending and the like can be suppressed.

In the interference filter according to the aspect of the invention, it is preferable that the metal film be an Ag alloy film containing silver (Ag) as a main component.

In the interference filter according to this configuration, the metal film is formed by the Ag alloy film. Since it is necessary to realize a high resolution and a high transmittance for the interference filter, it is preferable to use an Ag film, which is excellent in reflective and transmissive properties, as a material satisfying these conditions. On the other hand, the Ag film easily deteriorates in the manufacturing process or the environmental temperature. In contrast, since the deterioration in the manufacturing process or the environmental temperature can be suppressed by using the Ag alloy film, the high resolution and the high transmittance can be realized.

In the interference filter according to the aspect of the invention, it is preferable that the thickness of the Ag alloy film be equal to or larger than 30 nm and equal to or smaller than 60 nm.

In the interference filter according to this configuration, since the thickness of the Ag alloy film is equal to or larger than 30 nm and equal to or smaller than 60 nm, sufficient transparency can be maintained without reducing the transmittance of light incident on the Ag alloy film.

That is, if the thickness of the Ag alloy film is smaller than 30 nm, the reflectance of the Ag alloy film is decreased since the Ag alloy film is too thin. In addition, when forming the Ag alloy film using a sputtering method, the sputtering speed of the Ag alloy film is high since the Ag alloy film is thin. Accordingly, it becomes difficult to control the film thickness, and this may lower the manufacturing stability. On the other hand, if the thickness of the Ag alloy film exceeds 60 nm, the transmittance is decreased. Accordingly, it is not possible to acquire the sufficient amount of transmitted light. In contrast, the balance of the reflective and transmissive properties can be maintained satisfactorily by setting the thickness of the Ag alloy film to be equal to or larger than 30 nm and equal to or smaller than 60 nm. As a result, it is possible to improve the resolution and to acquire the sufficient amount of transmitted light.

In the interference filter according to the aspect of the invention, it is preferable that the transparent film be a titanium dioxide (TiO₂) film.

In the interference filter according to this configuration, the TiO₂ film with a high refractive index is used as a transparent film. Accordingly, it is possible to suppress a change in a desired half width. As a result, since the light transmittance can be increased, it is possible to further improve the resolution of the interference filter.

In the interference filter according to the aspect of the invention, assuming that the thickness of the transparent film is T, a measurement wavelength which is a wavelength of measurement light transmitted through the interference filter is λ, and the refractive index of the transparent film at the measurement wavelength is r, it is preferable that the thickness T of the transparent film satisfy Expression (1): T=λ/4r and the thickness T₁ of the transparent film be set in a range of 0.85T≦T₁≦1.25T.

Here, in the interference filter in which the gap between the reflective films is not changed, the measurement wavelength is a wavelength of light transmitted with multiple interference between these reflective films. In addition, in the interference filter in which the gap between the reflective films changes, the measurement wavelength is a center wavelength in a wavelength range which can be measured by gap change.

In the interference filter according to this configuration, the transparent film is formed in a thickness T satisfying the above Expression (1). Accordingly, since the transparent film shows high reflective properties for a desired measurement wavelength, the half width can be made smaller. For example, it is possible to maintain the desired half width in a predetermined wavelength range. As a result, since a decrease in the transmittance in a long wavelength range can be suppressed, it is possible to improve the resolution of the interference filter.

In addition, the thickness T₁ of the transparent film is set in the above-described range. Here, when the thickness T₁ is smaller than 0.85T and when the thickness T₁ is larger than 1.25T, the half width at the peak wavelength of light transmitted through the interference filter becomes larger than that in a configuration in which a metal film is provided on a dielectric multi-layer film. As a result, the resolution is reduced. In contrast, in the above-described range, the half width at the peak wavelength of light transmitted through the interference filter becomes smaller than that in the configuration in which a metal film is provided on a dielectric multi-layer film. As a result, the resolution can be improved. Thus, since the thickness T₁ of the transparent film is set in such a range, it is possible to increase the minimum amount of light in a predetermined wavelength range and to reduce the variation of the half width, for example. Therefore, it is possible to improve the resolution of the interference filter without reducing the detected amount of light, which is transmitted through the mirrors in a long wavelength range of near-infrared light, compared with that in a short wavelength range.

In the interference filter according to the aspect of the invention, it is preferable that the first and second substrates be formed of glass with a different refractive index from that of the transparent film.

In the interference filter according to this configuration, a high transmittance can be realized without reducing the light transmittance since each substrate is formed of glass with a different refractive index from that of the transparent film.

Another aspect of the invention is directed to an optical module including: the interference filter described above; and a light receiving section which receives light to be examined which has been transmitted through the interference filter.

Since the optical module according to the aspect of the invention includes the above-described interference filter with improved resolution, it is possible to detect the amount of light with a desired wavelength correctly.

Still another aspect of the invention is directed to an optical analyzer including: the optical module described above; and an analysis processing section which analyzes optical characteristics of the light to be examined on the basis of light received by the light receiving section of the optical module.

Since the optical analyzer according to the aspect of the invention includes the above-described optical module including the interference filter, it is possible to measure the amount of light with high precision and to measure the spectral characteristics correctly by executing optical analysis processing on the basis of the measurement result.

### BRIEF DESCRIPTION OF THE DRAWINGS

The invention will be described with reference to the accompanying drawings, wherein like numbers reference like elements.

FIG. 1 is a block diagram showing the schematic configuration of a color measuring device according to an embodiment of the invention.

FIG. 2 is a cross-sectional view showing the schematic configuration of an etalon according to the embodiment.

FIG. 3 is a graph showing the relationship between a wavelength range and the amount of light in the embodiment of the invention.

FIG. 4 is a graph showing the relationship between a wavelength range and the half width in the embodiment of the invention.

FIG. 5 is a graph showing the relationship between a change in the thickness of a TiO₂ film and the minimum amount of light in the embodiment of the invention.

FIG. 6 is a graph showing the relationship between a change in the thickness of a TiO₂ film and the variation of the half width in the embodiment of the invention.

### DESCRIPTION OF EXEMPLARY EMBODIMENTS

An embodiment of the invention will be described with reference to the accompanying drawings.

### 1. Schematic Configuration of a Color Measuring Device

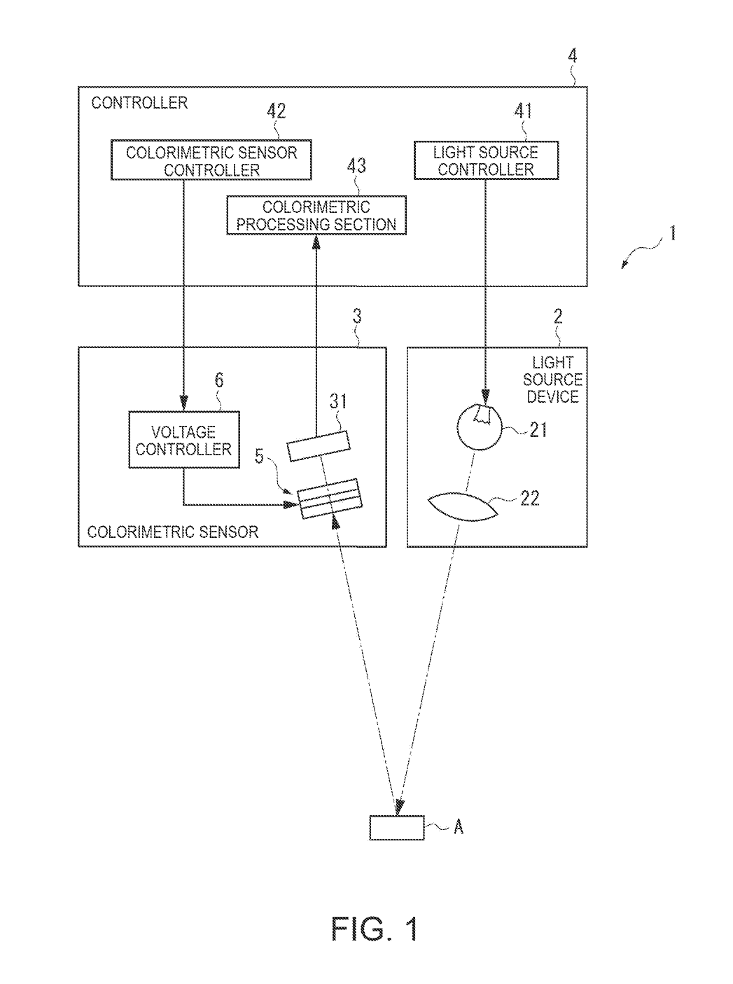

FIG. 1 is a block diagram showing the schematic configuration of a color measuring device 1 (optical analyzer) according to the present embodiment.

As shown in FIG. 1, the color measuring device 1 includes a light source device 2 which emits light to an object to be examined A, a colorimetric sensor 3 (optical module), and a controller 4 which controls the overall operation of the color measuring device 1. In addition, the color measuring device 1 is a device which reflects light emitted from the light source device 2 by the object to be examined A, receives the reflected light to be examined using the colorimetric sensor 3, and analyzes and measures the chromaticity of the light to be examined, that is, the color of the object to be examined A, on the basis of the detection signal output from the colorimetric sensor 3.

### 2. Configuration of a Light Source Device

The light source device 2 includes a light source 21 and a plurality of lenses 22 (only one lens is shown in FIG. 1), and emits white light to the object to be examined A. In addition, a collimator lens may be included in the plurality of lenses 22. In this case, the light source device 2 makes white light emitted from the light source 21 as parallel beams using the collimator lens and emits the parallel beams from a projector lens (not shown) toward the object to be examined A. In addition, although the color measuring device 1 including the light source device 2 is exemplified in the present embodiment, the light source device 2 may not be provided, for example, when the object to be examined A is a light emitting member, such as a liquid crystal panel.

### 3. Configuration of a Colorimetric Sensor

As shown in FIG. 1, the colorimetric sensor 3 includes an etalon 5 (interference filter), a light receiving element 31 (light receiving section) which receives light transmitted through the etalon 5, and a voltage controller 6 which changes the wavelength of light transmitted through the etalon 5. In addition, the colorimetric sensor 3 includes an optical lens for incident light (not shown) which is provided at the position facing the etalon 5 and which guides the reflected light (light to be examined), which is reflected by the object to be examined A, to the inside. In addition, the colorimetric sensor 3 separates only a light beam with a predetermined wavelength which is a measurement wavelength, among light beams to be examined incident from the optical lens for incident light, using the etalon 5 and receives the separated light beams using the light receiving element 31.

The light receiving element 31 is configured to include a plurality of photoelectric conversion elements and generates an electric signal corresponding to the amount of received light. In addition, the light receiving element 31 is connected to the controller 4 and outputs the generated electric signal to the controller 4 as a light receiving signal.

### 3-1. Configuration of an Etalon

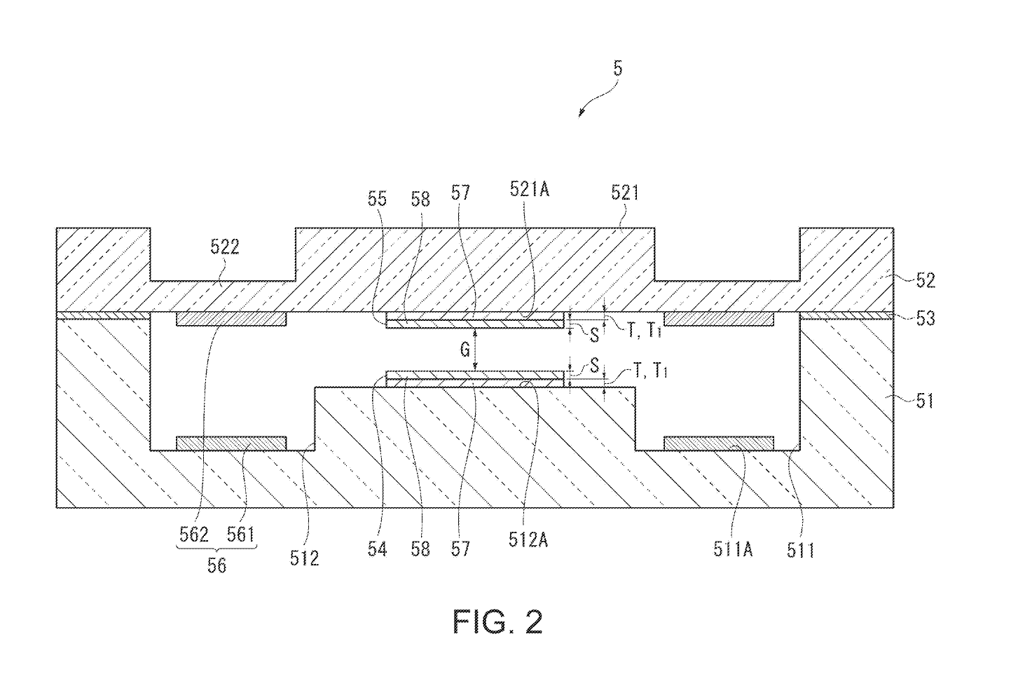

FIG. 2 is a cross-sectional view showing the schematic configuration of the etalon 5 in the present embodiment.

For example, the etalon 5 is a plate-shaped optical member, which has an approximately square shape in plan view, and its one side is formed with a size of 10 mm. As shown in FIG. 2, the etalon 5 includes first and second substrates 51 and 52. In addition, these substrates 51 and 52 are bonded to each other with a bonding layer 53 interposed therebetween, for example, by siloxane bonding using a plasma-polymerized film. That is, the first and second substrates 51 and 52 are integrally formed.

Here, the first and second substrates 51 and 52 are formed of a material with a different refractive index from the refractive index r of a TiO₂ film 57 which is a transparent film to be described later. Specifically, various kinds of glass materials, such as soda glass, crystalline glass, quartz glass, lead glass, potassium glass, borosilicate glass, alkali-free glass, and the like may be mentioned.

In addition, a fixed mirror 54 (first reflective film) and a movable mirror 55 (second reflective film) are provided between the first and second substrates 51 and 52. Here, the fixed mirror 54 is fixed to a surface of the first substrate 51 facing the second substrate 52, and the movable mirror 55 is fixed to a surface of the second substrate 52 facing the first substrate 51. In addition, the fixed mirror 54 and the movable mirror 55 are disposed to face each other with a gap G therebetween.

In addition, an electrostatic actuator 56 for adjusting the size of the gap G between the fixed mirror 54 and the movable mirror 55 is provided between the first and second substrates 51 and 52.

The electrostatic actuator 56 has a first electrode 561 provided at the first substrate 51 side and a second electrode 562 provided at the second substrate 52 side, and the first and second electrodes 561 and 562 are disposed to face each other. Each of the first and second electrodes 561 and 562 is connected to the voltage controller 6 (refer to FIG. 1) through an electrode lead-out section (not shown).

In addition, electrostatic attraction acts between the first electrode 561 and the second electrode 562 by the voltage output from the voltage controller 6, and the size of the gap G is adjusted. According to the gap G, the transmission wavelength of light transmitted through the etalon 5 is determined. That is, light transmitted through the etalon 5 is determined by appropriately adjusting the gap G using the electrostatic actuator 56, and the light transmitted through the etalon 5 is received by the light receiving element 31.

Next, the fixed mirror 54 and the movable mirror 55 will be described, and the detailed configuration of the etalon 5 will be described later.

### 3-1-1. Configurations of a Fixed Mirror and a Movable Mirror

Each of the fixed mirror 54 and the movable mirror 55 is formed to have a two-layer structure in which the one-layer titanium dioxide (TiO₂) film 57 (transparent film) and a one-layer silver (Ag) alloy film 58 (metal film) are laminated sequentially from the substrate side of each of the substrates 51 and 52. In addition, although not shown in the drawing, an oxide film formed of silicon (Si) is covered on the Ag alloy film 58 as a protective film. In addition, although the oxide film formed of silicon (Si) is used as a protective film in the present embodiment, an oxide film formed of aluminum (Al), a fluoride film formed of magnesium (Mg), and the like may be used.

The thickness T of the TiO₂ film 57 is set to satisfy the relationship of the following Expression (1). In addition, the thickness T₁ is set within the range of 0.85T≦T₁≦1.25T.

T=λ/4r (1)

λ is a center wavelength in the wavelength variation range of the etalon 5, and r is a refractive index of the TiO₂ film 57. Moreover, in the present embodiment, the wavelength-variable etalon 5 is exemplified. However, for example, in a wavelength-fixed etalon which does not have a configuration of changing the gap size, it is preferable to set the wavelength of transmitted light corresponding to the gap size as the measured wavelength λ.

In addition, although the TiO₂ film 57 is used as a transparent film in the present embodiment of the invention, it is preferable to use a film with a higher refractive index than the first substrate 51 or the second substrate 52. For example, an oxide film formed of tantalum (Ta) or an oxide film formed of niobium (Nb) may be used. Among these, the TiO₂ film which has the highest refractive index and shows good transmissive properties for light in a visible light range is preferable.

The thickness S of the Ag alloy film 58 is set to be equal to or larger than 30 nm and equal to or smaller than 60 nm.

This is because the balance of the transmittance and the reflectance of the fixed mirror 54 and the movable mirror 55 is important in the etalon 5.

That is, the high reflectance can be obtained by increasing the thickness S of the Ag alloy film 58 which forms the fixed mirror 54 and the movable mirror 55, but the transmittance is reduced. This becomes a problem in terms of the detection sensitivity as the etalon 5.

In particular, if the thickness S of the Ag alloy film 58 is smaller than 30 nm, the reflectance of the Ag alloy film 58 is low since the thickness S is too small. In addition, the reflectance decrease caused by processing or temporal change also becomes large. In addition, when forming the Ag alloy film 58 using a sputtering method, it is difficult to control the film thickness since the sputtering speed of the Ag alloy film 58 is high. This may lower the manufacturing stability.

On the other hand, the high transmittance can be obtained by decreasing the thickness S of the Ag alloy film 58 which forms the fixed mirror 54 and the movable mirror 55, but the reflectance is reduced. As a result, the spectral performance of the etalon 5 is lowered.

In particular, when the thickness S of the Ag alloy film 58 exceeds 60 nm, the light transmittance is reduced and the function of the etalon 5 as the fixed mirror 54 and the movable mirror 55 is also lowered accordingly.

From such a point of view, it is preferable to set the thickness S of the Ag alloy film 58, which forms the fixed mirror 54 and the movable mirror 55, to be equal to or larger than 30 nm and equal to or smaller than 60 nm. In this range, the thickness S of the Ag alloy film 58 is appropriately set such that the half width of the transmission wavelength becomes a desired value.

Ag—Sm—Cu alloy film containing silver (Ag), samarium (Sm), and copper (Cu)

Ag—C alloy film containing silver (Ag) and carbon (C)

Ag—Pd—Cu alloy film containing silver (Ag), palladium (Pd), and copper (Cu)

Ag—Bi—Nd alloy film containing silver (Ag), bismuth (Bi), and neodymium (Nd)

Ag—Ga—Cu alloy film containing silver (Ag), gallium (Ga), and copper (Cu)

Ag—Au alloy film containing silver (Ag) and gold (Au)

Ag—In—Sn alloy film containing silver (Ag), indium (In), and tin (Sn)

Ag—Cu alloy film containing silver (Ag) and copper (Cu)

In addition, it is also possible to use a metal film other than films formed of Ag. For example, a pure gold (Au) film, an alloy film containing gold (Au), a pure copper (Cu) film, and an alloy film containing copper (Cu) may be used. When the visible light range is set as a measured wavelength range, however, the Ag film is most excellent in terms of the reflective and transmissive properties.

### 3-1-2. Configuration of a First Substrate

The first substrate 51 is formed by etching a glass substrate with a thickness of 500 μm, for example. As shown in FIG. 2, an electrode forming groove 511 and a mirror fixing section 512 are formed in the first substrate 51 by etching.

In the electrode forming groove 511, a ring-shaped electrode fixing surface 511A is formed between the outer periphery of the mirror fixing section 512 and the inner peripheral wall surface of the electrode forming groove 511. The first electrode 561 described above is formed on the electrode fixing surface 511A in a ring shape.

As described above, the mirror fixing section 512 is formed with the same axis as the electrode forming groove 511 and in a cylindrical shape with a smaller diameter than the electrode forming groove 511. In addition, a mirror fixing surface 512A of the mirror fixing section 512 facing the second substrate 52 is formed more adjacent to the second substrate 52 than the electrode fixing surface 511A is. The fixed mirror 54 described above is formed on the mirror fixing surface 512A.

### 3-1-3. Configuration of a Second Substrate

The second substrate 52 is formed by etching a glass substrate with a thickness of 200 μm, for example.

Specifically, a circular movable section 521 with the central point of the substrate as its center in plan view in the substrate thickness direction (hereinafter, in plan view of an etalon) and a connection holding section 522, which has the same axis as the movable section 521, is formed in a circular shape in plan view of an etalon, and holds the movable section 521 so as to be able to move in the thickness direction of the second substrate 52, are formed in the second substrate 52.

The movable section 521 is formed to have a larger thickness than the connection holding section 522. In the present embodiment, for example, the movable section 521 is formed in a thickness of 200 μm which is the same as the thickness of the first substrate 52. In addition, the movable mirror 55 is formed on a movable surface 521A of the movable section 521 facing the first substrate 51.

The connection holding section 522 is a diaphragm surrounding the periphery of the movable section 521. For example, the connection holding section 522 is formed in a thickness of 50 μm. The second electrode 562 described above is formed in a ring shape on the surface of the connection holding section 522 facing the first substrate 51.

### 3-2. Configuration of a Voltage Controller

The voltage controller 6 controls a voltage, which is applied to the first and second electrodes 561 and 562 of the electrostatic actuator 56, on the basis of a control signal input from the controller 4.

### 4. Configuration of a Controller

The controller 4 controls the overall operation of the color measuring device 1. As the controller 4, for example, a general-purpose personal computer, a personal digital assistant, or a computer dedicated to color measurement may be used.

In addition, the controller 4 is configured to include a light source controller 41, a colorimetric sensor controller 42, and a colorimetric processing section 43 (analysis processing section), as shown in FIG. 1.

The light source controller 41 is connected to the light source device 2. In addition, the light source controller 41 outputs a predetermined control signal to the light source device 2, for example, on the basis of setting input from the user and emits white light with predetermined brightness from the light source device 2.

The colorimetric sensor controller 42 is connected to the colorimetric sensor 3. In addition, the colorimetric sensor controller 42 sets the wavelength of light received by the colorimetric sensor 3, for example, on the basis of setting input from the user and outputs to the colorimetric sensor 3 a control signal indicating the detection of the amount of received light with the wavelength. Then, the voltage controller 6 of the colorimetric sensor 3 sets a voltage, which is applied to the electrostatic actuator 56, on the basis of the output control signal such that only light with a wavelength that the user wants is transmitted through the etalon 5.

The colorimetric processing section 43 changes the gap between the mirrors of the etalon 5 by controlling the colorimetric sensor controller 42, thereby changing the wavelength of light transmitted through the etalon 5. In addition, the colorimetric processing section 43 acquires the amount of light transmitted through the etalon 5 on the basis of a light receiving signal input from the light receiving element 31. In addition, the colorimetric processing section 43 calculates the chromaticity of light reflected by the object to be examined A on the basis of the amount of received light with each wavelength obtained as described above.

### 5. Operations and Effects of the Present Embodiment

According to the present embodiment, each of the mirrors 54 and 55 is formed by laminating the one-layer TiO₂ film 57 and the one-layer Ag alloy film 58 sequentially from the substrate side. In such a configuration, absorption of light with a specific wavelength by a metal film can be suppressed compared with a configuration in which only a metal film is formed on a substrate or a configuration in which a dielectric multi-layer film is formed on a substrate and a metal film is formed on the dielectric multi-layer film. Accordingly, it is possible to suppress a decrease in the amount of transmitted light or a lowering in the resolution of the etalon 5. As a result, it is possible to improve the resolution of the etalon 5 without reducing the amount of transmitted light in a long wavelength range of near-infrared light.

In addition, the metal film is formed by the Ag alloy film 58. Since it is necessary to realize a high resolution and a high transmittance for the etalon 5, it is preferable to use an Ag film, which is excellent in the reflective and transmissive properties, as a material satisfying these conditions. On the other hand, the Ag film easily deteriorates in the manufacturing process or the environmental temperature. In contrast, since the deterioration in the manufacturing process or the environmental temperature can be suppressed by using the Ag alloy film 58, the high resolution and the high transmittance can be realized.

In addition, since the thickness S of the Ag alloy film 58 is equal to or larger than 30 nm and equal to or smaller than 60 nm, sufficient transparency can be maintained without reducing the transmittance of light incident on the Ag alloy film 58.

In addition, the TiO₂ film 57 with a high refractive index is used as a transparent film. Accordingly, it is possible to suppress a change in a desired half width. As a result, since the light transmittance can be increased, it is possible to further improve the resolution of the etalon 5.

In addition, the TiO₂ film 57 is formed in a thickness T satisfying the above Expression (1). Accordingly, it is possible to maintain the desired half width in a predetermined wavelength-variable range. As a result, since a decrease in the transmittance in a long wavelength range can be suppressed, it is possible to improve the resolution of the etalon 5.

In addition, the thickness T₁ of the TiO₂ film 57 is set in the above-described range of 0.85T≦T₁≦1.25T. Here, when the thickness T₁ is smaller than 0.85T and when the thickness T₁ is larger than 1.25T, the half width at the peak wavelength of light transmitted through the etalon 5 becomes larger than that in a configuration in which a metal film is provided on a dielectric multi-layer film. As a result, the resolution is reduced. In contrast, in the above-described range, the half width at the peak wavelength of light transmitted through the etalon 5 becomes smaller than that in the configuration in which a metal film is provided on a dielectric multi-layer film. As a result, the resolution can be improved. Thus, since the thickness T₁ of the TiO₂ film 57 is set in such a range, it is possible to increase the minimum amount of light in a predetermined wavelength-variable range and to reduce the variation of the half width, for example. Therefore, it is possible to improve the resolution of the etalon 5 without reducing the detected amount of light, which is transmitted through the mirrors 54 and 55 in a long wavelength range of near-infrared light, compared with that in a short wavelength range.

Each of the substrates 51 and 52 is formed of glass with a different refractive index from the refractive index of TiO₂ film 57. Accordingly, a high transmittance can be realized without reducing the light transmittance.

In addition, although both the fixed mirror of the first substrate and the movable mirror provided on the second substrate are formed by laminating the TiO₂ film and the Ag alloy film in the present embodiment, one of the mirrors may be formed by laminating the TiO₂ film and the Ag alloy film. Also in this case, the resolution of the interference filter can be improved compared with that in the related art.

### Modification of the Embodiment

In addition, the invention is not limited to the embodiment described above, but various modifications, improvements, and the like may also be made without departing from the scope and spirit of the invention.

Although the etalon 5 has been described as an interference filter according to the embodiment of the invention, the interference filter is not limited to this. A pair of mirrors formed by the metal film and the transparent film described above may also be applied to an interference filter in which the size of a gap between mirrors is not changed.

In the embodiment, the configuration of the etalon 5 in which the gap G between mirrors can be adjusted by the electrostatic actuator 56 is exemplified. However, for example, it is also possible to adopt a configuration in which an electromagnetic actuator including a magnet coil and a permanent magnet or a piezoelectric element, which can be expanded and contracted by application of a voltage, is provided.

In the embodiment, the substrates 51 and 52 are bonded to each other by the bonding layer 53 interposed therebetween. However, bonding of the substrates 51 and 52 is not limited to this. For example, the bonding layer 53 is not formed, the substrates 51 and 52 may be bonded to each other by so-called room temperature activation bonding, which is to bond the substrates 51 and 52 by activating the bonding surfaces of the substrates 51 and 52 and applying pressure in a state where the substrates 51 and 52 overlap each other. That is, any kind of bonding method may be used.

In the embodiment, the thickness of the second substrate 52 is set to 200 μm, for example. However, the thickness of the second substrate 52 may be set to 500 μm which is the same thickness as the first substrate 51. In this case, since the thickness of the movable section 521 also becomes 500 μm to be thick, bending of the movable mirror 55 can be suppressed. As a result, the mirrors 54 and 55 can be maintained in more parallel.

In addition, the colorimetric sensor 3 is exemplified as an optical module according to the embodiment of the invention, and the color measuring device 1 including the colorimetric sensor 3 is exemplified as an optical analyzer according to the embodiment of the invention. However, the optical module and the optical analyzer according to the embodiment of the invention are not limited to these. For example, a gas sensor into which gas is introduced and which detects light absorbed by gas among incident light beams may be used as the optical module according to the embodiment of the invention, and a gas detector which analyzes and determines gas introduced into the sensor by such a gas sensor may be used as the optical analyzer according to the embodiment of the invention. In addition, the optical analyzer may be a spectral camera or a spectrometer including such an optical module.

In addition, it becomes possible to transmit data with light with each wavelength by temporally changing the intensity of light with each wavelength. In this case, by separating light with a specific wavelength using the etalon 5 provided in the optical module and receiving the separated light using the light receiving section, it is possible to extract the data transmitted by the light with a specific wavelength. By processing the data of light with each wavelength using an optical analyzer including such an optical module for data extraction, it is also possible to execute optical communication.

### EXAMPLES

### 1. Change in the Amount of Light in a Wavelength Range and Evaluation of a Change in the Half Width

### First Example

The etalon 5 in which the wavelength-variable region was set to 600 nm to 1100 nm and a TiO₂ film and an AgSmCu alloy film were formed as a transparent film and a metal film in the fixed mirror 54 and the movable mirror 55, respectively, was manufactured (gap changeable amount of 200 to 460 nm).

In the etalon 5, the thickness T of the TiO₂ film 57 was set to 92 nm using the above Expression (1). In addition, the thickness S of the AgSmCu alloy film was set to 51 nm in order to set the half width of a peak wavelength to 10 nm.

### First Comparative Example

An etalon in which a single film of an Ag—Sm—Cu alloy film was formed at the substrate side was manufactured. In this case, the thickness of the Ag—Sm—Cu alloy film was set to 46.5 nm in order to set the half width of a peak wavelength to 10 nm.

### Second Comparative Example

An etalon in which a laminate of a TiO₂ film and a silicon dioxide (SiO₂) film and an Ag—Sm—Cu alloy film on the laminate were formed sequentially from the substrate side was manufactured. In this case, in order to set the half width of a peak wavelength to 10 nm, the thickness of the TiO₂ film was set to 46 nm, the thickness of the SiO₂ film was set to 73 nm, and the thickness of the Ag—Sm—Cu alloy film was set to 49 nm.

### Evaluation

Light emitted from a light source with the same intensity in the target wavelength range was incident on the respective etalons in the first example, the first comparative example, and the second comparative example, and the gap size in each etalon was changed.

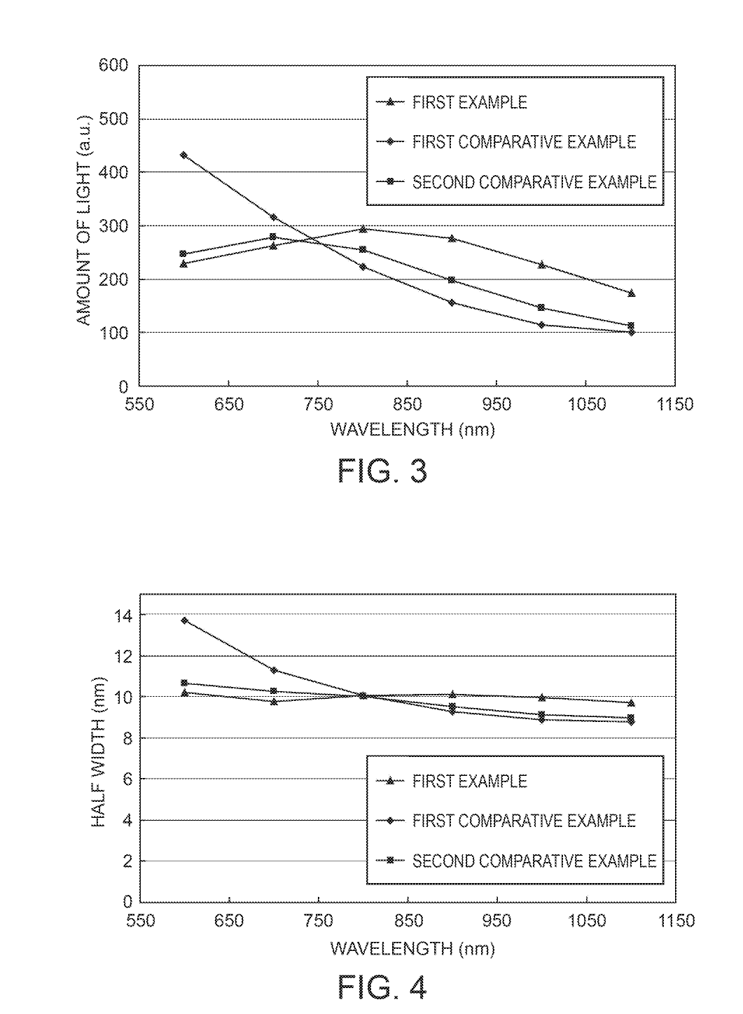

As a result, changes (graph shown in FIG. 3) in the amount of light in a wavelength-variable range (600 nm to 1100 nm) and changes (graph shown in FIG. 4) in the half width in the above-described wavelength range were obtained.

As shown in FIG. 3, in the first example, it was confirmed that a decrease in the amount of light in a long wavelength range of near-infrared light was small compared with that in the first and second comparative examples. Specifically, it was confirmed that the amount of light at the wavelength of 1100 nm in the first example was about 1.8 times that in the first and second comparative examples. In addition, it was confirmed that the ratio of the amount of transmitted light largely changed with a wavelength in the first and second comparative examples, but almost the same transmittance was obtained at each wavelength in the first example.

As shown in FIG. 4, in the first example, it could be seen that the half width was almost constant as 10 nm, which was a desired half width, in a wavelength range, compared with that in the first and second comparative examples. On the other hand, in the first comparative example, it could be seen that the half width was 10 nm at a wavelength of about 800 nm, but a change in the half width within the wavelength range was large. In particular, the half width at a wavelength of 600 nm was 14 nm. In addition, in the second comparative example, it was confirmed that a change in the half width with a half width of 10 nm as a reference was not large compared with that in the first comparative example, but the change in the half width was large and the wavelength dependency was strong compared with that in the first example. In contrast, in the first example, it was confirmed that the half width was constant in the entire wavelength range and there was no lowering in the wavelength dependency according to the resolution.

As described above, in the first example, it could be seen that a decrease in the amount of light in a long wavelength range of near-infrared light was small and it was constant in the entire wavelength range for a desired half width of 10 nm. In addition, in the first example, the thickness S of the Ag—Sm—Cu alloy film was set to 51 nm and the thickness was larger than that in the first and second comparative examples, but the half width could be constantly maintained within the wavelength range without reducing the amount of transmitted light in the long wavelength range of near-infrared light and the resolution could be improved accordingly.

### 2. Change in the Minimum Amount of Light to a Change in the Thickness T of a TiO₂ Film and Evaluation on the Variation of the Half Width

Next, six etalons 5 (first to sixth examples) obtained by changing the thickness T of the TiO₂ film 57 in the etalon 5 of the first example described above were prepared.

### Second Example

The thickness T₁ of the TiO₂ film 57 was set to 73.6 nm (0.8T).

### Third Example

The thickness T₁ of the TiO₂ film 57 was set to 82.8 nm (0.9T).

### Fourth Example

The thickness T₁ of the TiO₂ film 57 was set to 101.2 nm (1.1T).

### Fifth Example

The thickness T₁ of the TiO₂ film 57 was set to 110.4 nm (1.2T).

### Sixth Example

The thickness T₁ of the TiO₂ film 57 was set to 119.6 nm (1.3T).

### Evaluation

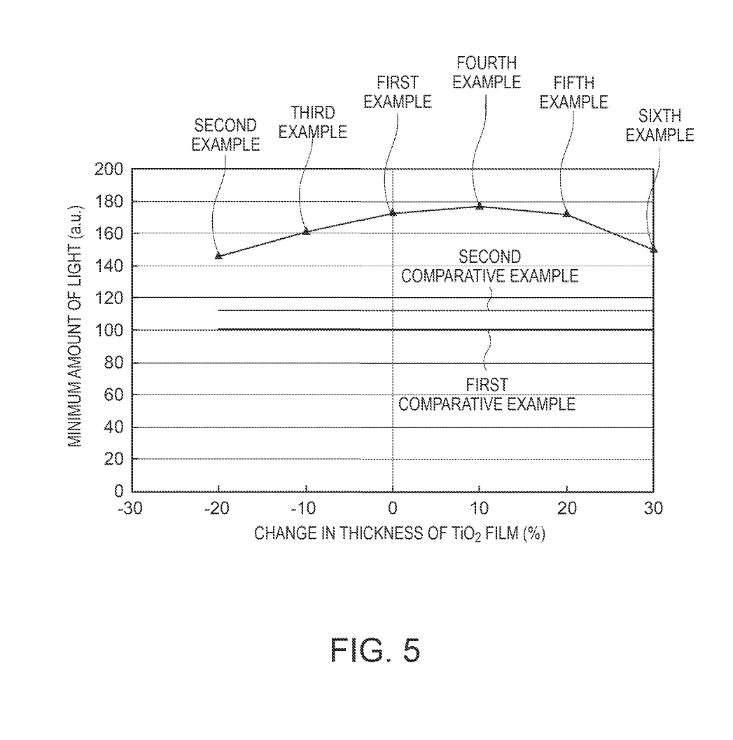

The minimum amount of light when a transmission wavelength was changed in a range of 600 to 1100 nm was detected in the first to sixth examples and the first and second comparative examples. The result is shown in a graph of FIG. 5.

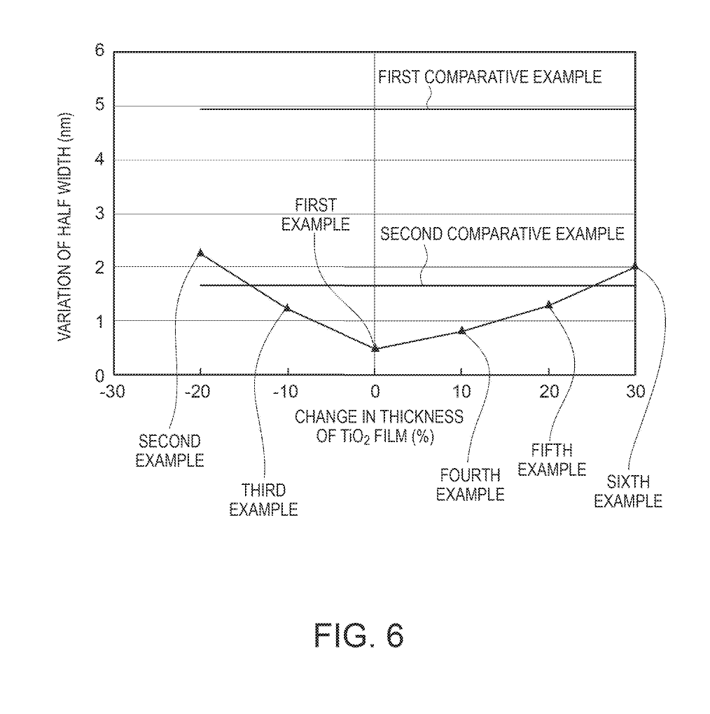

In addition, a variation of the half width when a transmission wavelength was changed in a range of 600 to 1100 nm was detected in the first to sixth examples and the first and second comparative examples. The result is shown in a graph of FIG. 6.

In addition, although the graphs of the first and second comparative examples in FIGS. 5 and 6 are shown for comparison with the examples, this data shows each typical level and does not show the value when the thickness of the TiO₂ film changes.

As shown in FIG. 5, the minimum amount of transmitted light in the first comparative example was 100, and the minimum amount of transmitted light in the second comparative example was about 110.

In contrast, in the first to sixth examples, the minimum amount of transmitted light exceeding those in the first and second comparative examples was confirmed.

As shown in FIG. 6, the maximum variation of the half width in the first comparative example was about 5 nm, and the maximum variation of the half width in the second comparative example was about 1.6 nm.

On the other hand, in the second and sixth examples (when the thickness T₁ of the TiO₂ film was smaller than T-15% (0.85T) and when the thickness T₁ of the TiO₂ film was larger than +25% (1.25T)), the maximum variation of the half width was smaller than that in the first comparative example but larger than the second comparative example. On the other hand, in the first and third to fifth examples (when the thickness T₁ of the TiO₂ film was equal to or larger than T-15% and equal to or smaller than +25%), the maximum variation of the half width was smaller than that in the first and second comparative examples.

From the above, it could be seen that the conditions, in which the maximum variation of the half width was smaller than that in the first and second comparative examples, were that the thickness T₁ of the TiO₂ film was 0.85T≦T₁≦1.25T.

As described above, the minimum amount of light when the thickness T₁ of the TiO₂ film is set in a range of 0.85T≦T₁≦1.25T exceeds the minimum amount of light in the first and second comparative examples. Therefore, it could be seen that the minimum amount of light could be made larger than that in the first and second comparative examples and the maximum variation of the half width can be made smaller than that in the first and second comparative examples by setting the thickness T₁ of the TiO₂ film in a range of 0.85T≦T₁≦1.25T.

The entire disclosure of Japanese Patent Application No. 2010-259044, filed Nov. 19, 2010 is expressly incorporated by reference herein.

What is claimed is:

1. An interference filter comprising:
a first reflective film; and
a second reflective film disposed so as to face the first reflective film with a gap therebetween,
wherein the first reflective film is formed by laminating a one-layer transparent film and a one-layer metal film, and
the second reflective film is formed by laminating a one-layer transparent film and a one-layer metal film.

2. The interference filter according to claim 1, further comprising:
a first substrate; and
a second substrate facing the first substrate,
wherein the first reflective film is provided on a surface of the first substrate facing the second substrate and is formed by laminating the one-layer transparent film and the one-layer metal film sequentially from the first substrate side, and
the second reflective film is provided on the second substrate, faces the first reflective film with a predetermined gap therebetween, and is formed by laminating the one-layer transparent film and the one-layer metal film sequentially from the second substrate side.

3. The interference filter according to claim 1,
wherein the metal film is an Ag alloy film containing silver (Ag) as a main component.

4. The interference filter according to claim 3,
wherein the thickness of the Ag alloy film is equal to or larger than 30 nm and equal to or smaller than 60 nm.

5. The interference filter according to claim 1,
wherein the transparent film is a titanium dioxide (TiO₂) film.

6. The interference filter according to claim 1,
wherein assuming that the thickness of the transparent film is T, a measurement wavelength which is a wavelength of measurement light transmitted through the interference filter is λ, and the refractive index of the transparent film at the measurement wavelength is r, the thickness T of the transparent film satisfies Expression T=λ/4r, and
the thickness T₁ of the transparent film is set in a range of 0.85T≦T₁≦1.25T.

7. The interference filter according to claim 2,
wherein the first and second substrates are formed of glass with a different refractive index from that of the transparent film.

8. An optical module comprising:
the interference filter according to claim 1; and
a light receiving section which receives light to be examined which has been transmitted through the interference filter.

9. An optical analyzer comprising:
the optical module according to claim 8; and
an analysis processing section which analyzes optical characteristics of the light to be examined on the basis of light received by the light receiving section of the optical module.
